(19) United States
(12) Patent Application Publication
(10) Pub. No.: US 2015/0287019 A1
(43) Pub. Date: Oct. 8, 2015

(54) METHOD IN A NON WEB-BASED APPLICATION OF A MOBILE DEVICE FOR TRANSFERRING FUNDS TO A SAVINGS ACCOUNT

(71) Applicant: FEDERATION DES CAISSES DESJARDINS DU QUEBEC, Levis (CA)

(72) Inventors: Stephane Barsalou, Montreal (CA); Claude Heon, Boucherville (CA); Jean-Pierre Malo, Montreal (CA)

(21) Appl. No.: 14/681,576

(22) Filed: Apr. 8, 2015

Related U.S. Application Data
(60) Provisional application No. 61/976,696, filed on Apr. 8, 2014.

(30) Foreign Application Priority Data
Jul. 3, 2014 (CA) 2855740

(51) Int. Cl. G06Q 20/32; G06Q 20/10; H04W 12/06

(52) U.S. Cl. CPC G06Q 20/3223; H04W 12/06; G06Q 20/10

(57) ABSTRACT

A method in a non web-based application of a mobile device for transferring funds to a banking account comprises receiving from a server system an identifier token of the mobile device. The identifier token is persistently stored at the mobile device. When funds are to be transferred, the identifier token stored is sent at the mobile device to the server system when the non web-based application is opened in the mobile device to transfer funds to the banking account. Information identifying a balance of at least one source account is received, from the server system, and displayed, along with an editable amount of funds to be transferred to the banking account and an indication of a single action to be performed to transfer the funds to the banking account. A request for fund transfer of the editable amount is sent to the server system along with the identifier token in response to the single action being performed.

### CROSS-REFERENCE TO RELATED APPLICATION

The present application claims priority on U.S. Provisional Patent Application No. 61/976,696, filed on Apr. 8, 2014, and on Canadian Patent Application No. 2,855,740, filed on Jul. 3, 2014.

### TECHNICAL FIELD

The present application relates to banking transactions with mobile devices and, more particularly, to savings transactions.

### BACKGROUND OF THE ART

The evolution of telecommunications has had a transformational impact on financial transactions. Internet shopping, for example, has become a common occurrence and has gained important market shares from traditional styles of shopping. Accordingly, numerous systems have been designed to simplify or enhance the shopping experience. Typically, online shopping platforms have been simplified to the point that very few operations are required for a buyer to complete a transaction. For instance, Canadian Patent No. 2,246,933, describes a system and methods that allow the purchaser to complete a transaction with a simple click from a web-based platform, to complete a transaction without the need to fill out numerous fields.

A common trait is that many improvements in transactional systems and methods are related to expenses. The simplification of online transactions has been designed to facilitate purchases, which caters to the compulsive buyer. Moreover, methods and systems such as those of Canadian Patent No. 2,246,933 allow transactions that do not involve bank accounts, and thus do not have to deal with the highly regulated security and sensitivity required by banking transactions.

Financial transactions with banks remain somewhat complex, for security reasons. For example, for fraud protection, such transactions are known to be more complex and require more steps, and cannot readily be simplified. A user must often inevitably login, spending precious time entering a password, etc.

### SUMMARY

It is therefore an aim of the present disclosure to provide a method for performing savings transactions that overcome issues related to the prior art.

Therefore, in accordance with an embodiment of the present disclosure, there is provided a method in a non web-based application of a mobile device for transferring funds to a banking account, the method comprising: receiving from a server system an identifier token of the mobile device; persistently storing the identifier token at the mobile device; when funds are to be transferred: sending the identifier token stored at the mobile device to the server system when the non web-based application is opened in the mobile device to transfer funds to the banking account, receiving, from the server system, and displaying information identifying a balance of at least one source account, and an editable amount of funds to be transferred to the banking account, along with an indication of a single action to be performed to transfer the funds to the banking account, and sending to the server system a request for fund transfer of the editable amount along with the identifier token in response to the single action being performed.

In accordance with another embodiment of the present disclosure, there is provided a method for transferring funds to a banking account by a transaction server based on a request from a non web-based application of a mobile device, the method comprising: upon validation of a user identity via a mobile device, sending an identifier token uniquely identified to mobile device for persistent storage at the mobile device; when funds are to be transferred by communication from the mobile device with the identifier token: obtaining, from at least one account server, a balance of at least one source account, sending to the mobile device the balance of the at least one source account and an editable amount of funds to be transferred to a banking account, for display, receiving a request for fund transfer of the editable amount along with the identifier token in response to a single action transfer being performed at the mobile device, recognizing the identifier token, and sending to the account server the request for fund transfer of the editable amount to the banking account.

### DESCRIPTION OF THE DRAWINGS

FIG. 1 is a block diagram of a system enabling fund transfers to a savings account using a non web-based application of a mobile device, in accordance with the present disclosure;

FIGS. 2A-2C are flowcharts concurrently illustrating a method for transferring funds to a savings account, as performed by a non web-based application of a mobile device;

FIGS. 3A-3C are flowcharts concurrently illustrating a method for transferring funds to a savings account based on a request from a non web-based application of a mobile device; and

FIG. 4 is a flow chart illustrating a method for notifying the user of a mobile device of activity status, further to the methods of FIGS. 2A to 2C and 3A to 3C.

### DETAILED DESCRIPTION

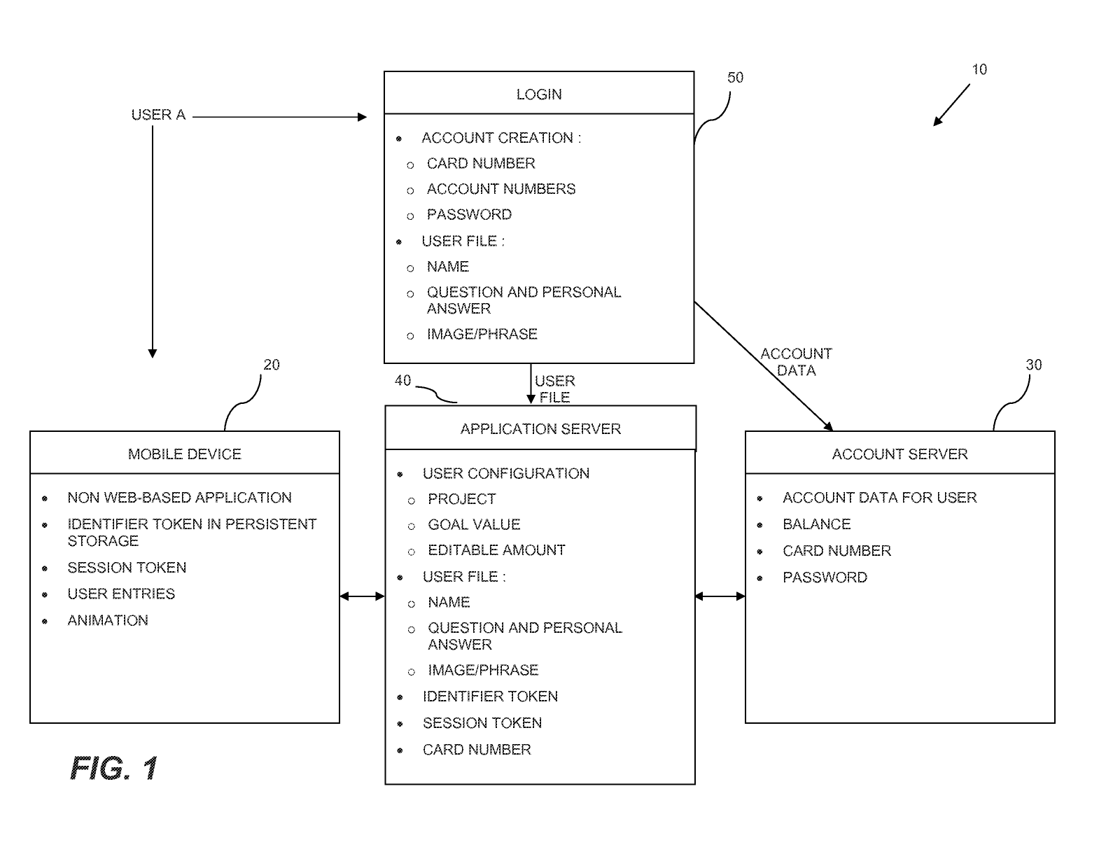

Referring to the drawings, and more particularly to FIG. 1, a system for performing savings transactions using a mobile device is generally shown at 10. The system 10 involves a user A that performs such transactions with his/her mobile device 20. The mobile device 20 is typically a cellular phone (a.k.a., a mobile phone, a smartphone, etc) that incorporates a non web-based application allowing such transactions, the non web-based application being a machine-executable coded instruction set configured to cause the data processor in the mobile device 20 to perform a method described below. Hence, other mobile devices, including for instance tablets, watches, PDAs, having telecommunications capability for instance using Wi-Fi alternatively to the cellular network, may also qualify as mobile device 20. With the mobile device 20, the user A accesses bank server systems to perform savings transactions. By way of the application, the mobile device 20 may perform animations and calculations related to the savings transactions. The bank server systems include the account server 30, an application server 40, and a login server 50, all of which servers 30, 40 and 50 may include a plurality of different servers, but are referred to server in the singular for simplicity, although multiple servers are likely involved. Moreover, although the expression “bank” is used, the expression refers to financial institutions offering savings services.

The account server 30 (a.k.a., a transaction server) manages the source accounts and the savings accounts, and is conventionally highly secure, with limited access. In the embodiment of FIG. 1, the account server 30 has the account numbers, balances, the card numbers and the passwords specific to the user A.

The application server 40 is the interface between the mobile device 20 and the account server 30. The application server 40 will simplify the requirements to perform transfers to the savings account. The application server 40 manages and stores the user configuration as described hereinafter, and performs validation using data received as part of a user file, namely the question and personal answer, the user-selected image and/or phrase. The application server 40 also generates the tokens. In an embodiment, an identifier token is generated for persistent storage in the mobile device 20. By persistent storage, the present disclosure refers to the fact that a same identifier token may be used for numerous sessions. In an embodiment, the identifier token is permanent. In another embodiment, the identifier token must be replaced after the expiry of an allotted time period (e.g., 90 days). It is considered to use a unique identifier as identifier token. A session token is also generated, and the session token is used at most for one session by the mobile device 20, to change settings in the user configuration. For instance, if the application is closed, a new session token is required. Likewise, if the allotted session time has expired (e.g., 5 minutes), the user is timed out, and a new session token may be required.

The system servers also feature the login server 50 by which the user A can create accounts to subsequently perform savings transactions in the manner described hereinafter. The login server 50 may require interventions from the financial institution to create accounts, or may be operated by personnel from the financial institution responding to a call from the user A. The login server 50 collects data of a user file, including identity of the user, question and personal answer, user-selected image/phrase, a password. The login server 50 shares the information to the account server 30 and the application server 40.

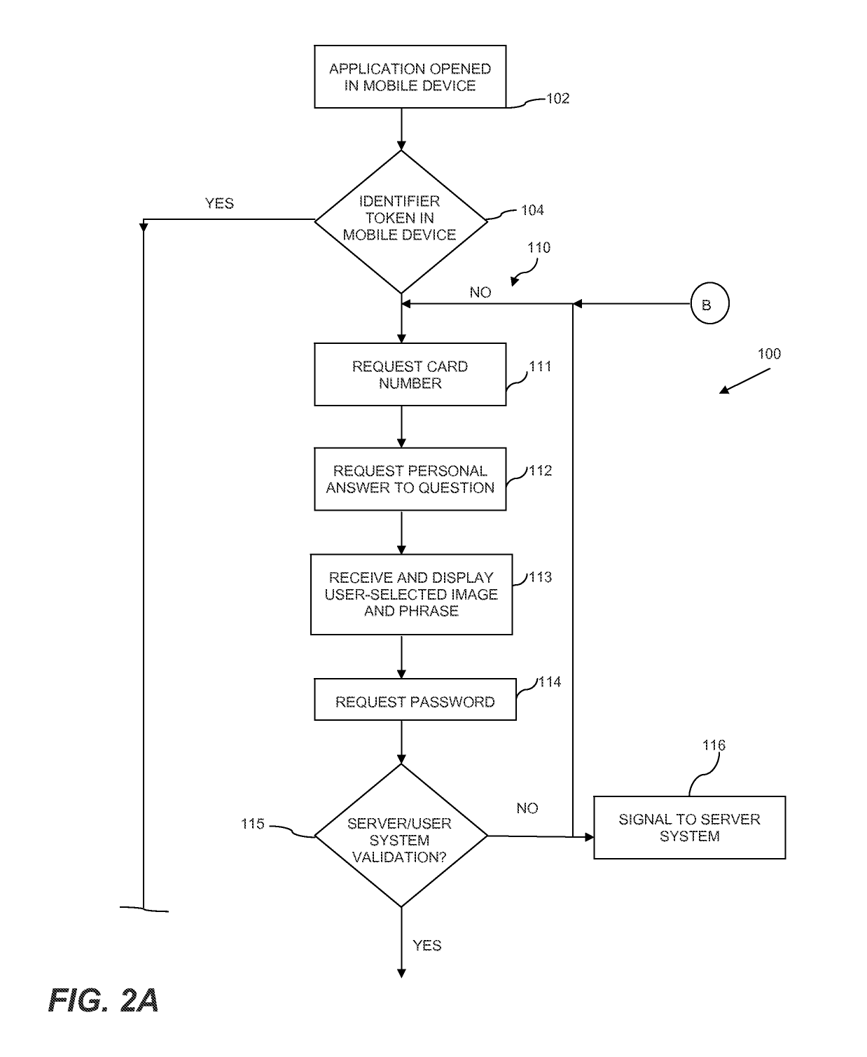

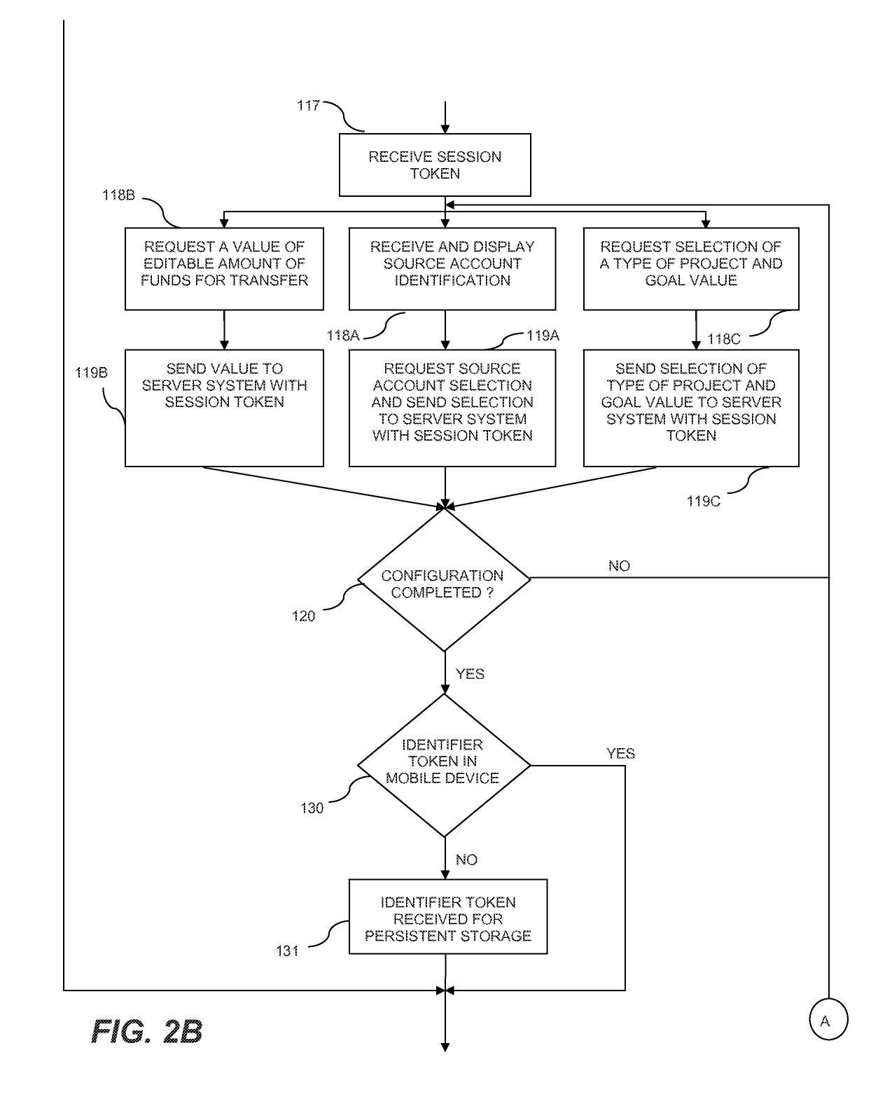

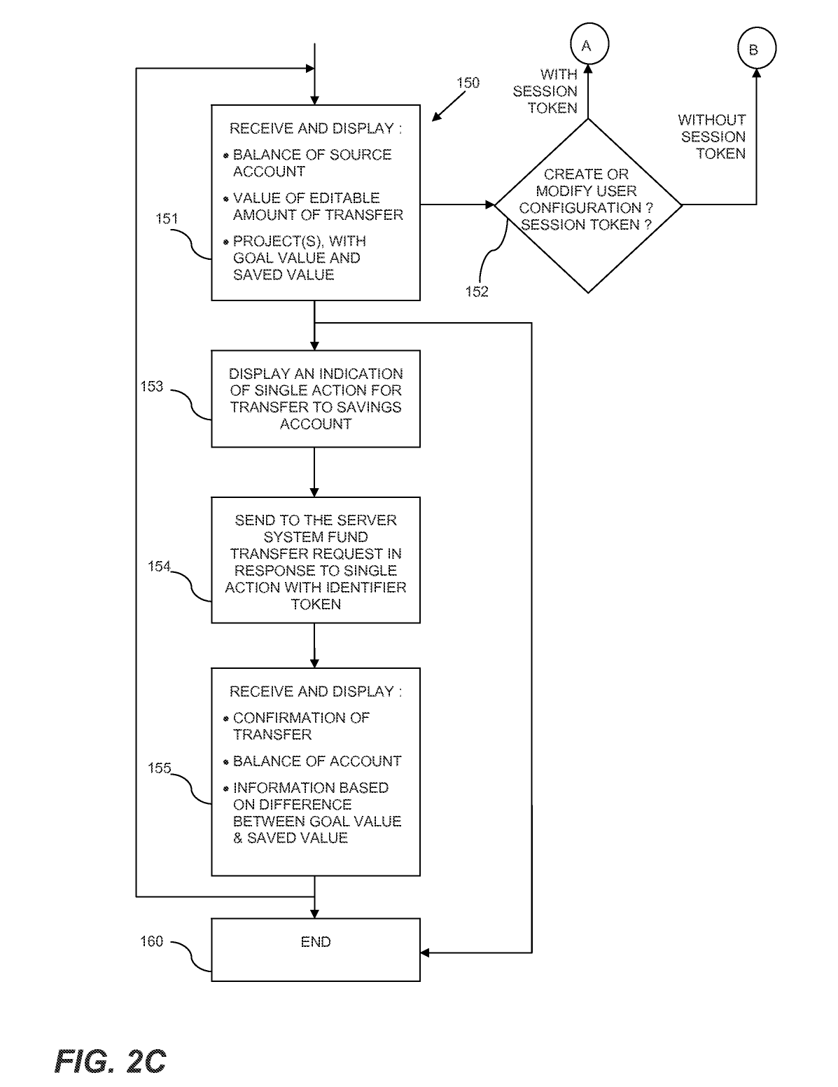

Referring concurrently to FIGS. 1 and 2A-2C, there is illustrated a method for transferring funds to a savings account at 100. The method 100 is of the type that is performed by the mobile device 20 running the non web-based application in the arrangement of the system 10 of FIG. 1. For instance, the method 100 is executed by a computer program product, i.e., the application, stored in the memory of the mobile device 20 in the form of computer executable instructions.

According to 102, the non-web-based application is opened on the mobile device 20. At this point, the application has been downloaded and installed on the mobile device 20. Moreover, the web login has been performed, whereby a user account exists in the account server 30, and a user file saved as initial configuration is in the application server 40.

In being opened, the application will verify if an identifier token is already in the mobile device, at 104. Assuming that it is user A's first login, the mobile device 20 must be initiated and configured for single-action transfers to be performed. If the identifier token is not in the mobile device at 104, the method 100 follows the sequence of steps shown at 110, to login to the application server 40, which login steps may not be required for the user A to perform single-action transfers occurring later on, as will be described.

According to 111, the card number is requested. Considering that the web login has been performed, a card number has already been granted, and the user A has already set a password for the card number in the login 50. The server system hence already has a record of the card number associated with the user file and user accounts. 111 may be performed only when the user configuration is created, with an option for the user A to have the mobile device 20 remember the card number for subsequent user modifications.

In 112, a personal answer may be requested to a question. This information, i.e., the question and personal answer, is obtained from the server system, based on the initial web login 50. In an embodiment, the personal answer and card number validation is done by the application server 40.

According to 113, a user-selected image/phrase resulting from the web login is received by the mobile device 20 from the server system and displayed. In an embodiment, the user-selected image/phrase is provided by the application server 40. This is an anti-phishing function that may be performed by the system 10, based on the cooperation from the user A. While 113 may feature both an image and a phrase, a single of these two options could be provided in 113. For instance, the phrase may be less demanding in terms of bandwidth.

In 114, the password is requested for the card number. The password of 114 is associated with the card number of 111. Accordingly, the server system may already validate the password associated with the card number. In an embodiment, the password and card number validation is done by the account server 30. Although the personal answer to question as per 112 is requested prior to the password as in step 114, to add another level of safety prior to allowing access to the configuration (especially of the card number is memorized by the device 20 after the creation of the user configuration), these steps may be switched such that the password is obtained prior to the personal answer to question.

The steps 111, 112, 113 and 114 of the sequence 110 may be performed in any appropriate order, jointly or separately. In an embodiment, a single application page may deal with the card number and password, while another application page may display the information based on the steps 113 and 114.

Accordingly, as identified in 115, the server system performs a validation when the user A logs in, the validation being accomplished on two different levels for example, namely the account server 30 and the application server 40. If, at the outset of 115, validation is not completed, the sequence 110 may be repeated, or an alert signal may be sent to the server system as shown at 116. For instance, if a given amount of attempts has been performed with the sequence 110, the signalling of 116 may be reached to alert bank authorities.

If the server system validates the information at 115, a session token is received as shown at 117, which session token is necessary for subsequent configuration entries or modifications, generally shown by steps 118 and 119.

According to 118A, the mobile device 20 receives and displays source account identification. This may include one or more source accounts, which source accounts have been attributed or configured at the web login 50. The information may be provided by the account server 30.

When the source account identification is received and displayed at 118A, the user is requested to select or confirm a source account and to send the selection to the server system, as shown at 119A. 119A may also allow the creation of a savings account. When sending the selection to the servers, the session token obtained in step 117 is attached to the selection by the mobile device 20, for validation by the server system. Accordingly, the servers will set the selection received in the user configuration.

Alternatively, or supplementally, in 118B, a value of the editable amount of funds for transfer is entered. The value is in the appropriate currency and represents the value of the fund transfer that will be stored in the user configuration.

According to 119B, the value is sent to the server system (e.g., application server) to be set in the user configuration with the session token attached to confirm this configuration setting. Although the value is stored in the user configuration, it may be changed subsequently, as described hereinafter. However, the registration of the value in the user configuration may help in allowing the user A to transfer funds without having to enter an amount, at the single-action transaction.

Furthermore, the application may request a selection of a type of project at 118C. For instance, the projects may be qualified as travel, emergency fund, real estate, etc. In the case of a travelling project, the selection of 118C may include a destination entered by the user A. Moreover, 118C may also include a goal value, namely a currency amount user A aims at reaching. The goal value is discretionary to the user A and may for instance be a travel budget, air fare, etc.

In 119C, the selection of type of project and the goal value are sent to the server system, with the session token attached, and the selection is set in the user configuration.

The application may require only some of the data required in steps 118 and 119, if any. For instance, the selection or confirmation of source account may be the only required selection or confirmation of the user configuration to enable single-action transfers.

In 120, the application ensures that the user configuration is complete, i.e., that all necessary information has been entered for single-action transactions to be made, and runs steps 118 and 119 until configuration is completed.

If the user configuration is complete, as identified at 130, it is determined if an identifier token is present in the mobile device 20. If not, as per 131, an identifier token is received, for persistent storage in the mobile device 20. The identifier token may be provided by the application server 40. The verification performed at 130 is necessary in the event that the application has reached 130 in modifying the user configuration after the initial login, as opposed to creating a user configuration when login the mobile device 20 at first-time use. The initial login is performed to create the user configuration and to obtain an identifier token, these items subsequently allowing the single-action transfers. It is observed that a modification of the configuration will necessitate that the user passes through the sequence of steps 110 to obtain a session token as per 117, the session token being required to modify the configuration settings.

When the user configuration has been completed according to the steps described above, and if the mobile device 20 comprises an identifier token, the sequence of steps shown at 150 may be performed, for a single-action transfer to be executed.

Accordingly, when funds are to be transferred, as per 151, the mobile device 20 automatically receives information from the server system and displays same, upon turning the non web-based application on in the mobile device 20. The information may include the balance of the source account(s) and savings account, the value of the editable amount of funds to be transferred, the types of projects, and/or the goal value per project and saved value (or balance of savings account) for the selected projects. Although 151 shows data obtained from the user configuration settings, it is pointed out that sequence 150 may offer the possibility of a selection or manual entries by the user A, for instance for selection of one of multiple projects that have been entered at user configuration for the user A of the mobile device 20.

It may be desired by the user A to create a user configuration (at the first-time login) or to make modifications to the user configuration, upon seeing the information displayed by 151. Accordingly, as shown at 152, two different paths may be taken, depending on whether there is an active session token. Indeed, the session token is necessary for user configuration modifications/creation. If there is no session token that is active, the user A may be required to log in as per the sequence of steps 110 to then receive a session token at 117. If there is an active session token, the mobile device may jump to the configuration steps 118 and 119.

According to 153, the information displayed at 151 features an indication of a single action to be performed by the user A with the interface of the mobile device 20, for transfer of funds in the editable amount to the savings account. Stated differently, the indication is a one-click savings indication. The indication may be a button on the touchscreen of the mobile device 20, or indication of a key of the keyboard to be pressed to perform the transaction, for the transaction to be completed in accordance with the details that are displayed on the mobile device 20. Upon performing the single action in 153, a signal is sent at 154 to the server system for fund transfer request. The identifier token is attached to the fund transfer request sent to the server system, along with the editable value, and additional information if necessary (e.g., an updated goal value), the additional information being that being editable on the single-action transfer screen of the mobile device 20 (i.e., outside of the user configuration). Indeed, it is for example contemplated to allow a change in the goal value without having to perform steps 118C and 119C. Alternatively, after seeing the information of 151 (e.g., source account balance), the user A may decide to end the session without performing a transaction, as shown in FIG. 2C. In such a case, the application enables the user A to see account balances, the mobile device 20 using the identifier token to do so.

As a response to the fund transfer request, 155 suggests receiving and displaying the confirmation of the transfer, as received from the server system. The mobile device 20 may perform some form of animation, which may include displaying information such as the balance of the account(s), and information based on the difference between the goal value and the saved value of the project. According to an example, information that may be provided is the number of clicks (i.e., single-action transfers) remaining to reach the goal value. This information may be calculated by the application at the mobile device 20, or received as data calculated by the server system. If a destination has been entered in the case of a travel budget, it may be desired to send whether data associated with the travel destination, by having the mobile device 20 browse this information. The mobile device 20 may also push special notifications under 155, upon reaching milestones or as motivational messages to encourage savings. For instance, once the user A has reached or surpassed 50% of the goal, a special notification may be produced to announce the milestone.

The sequence of steps 150 may be repeated for subsequent transfers or the application may be closed as per 160. It is observed that the steps 151, and 153-155 involve identity-less data exchanged between the mobile device 20 and the application server 30. Stated differently, when the mobile device 20 is not in a configuration mode—the configuration mode being the sequences 118, 119, 120, 130 and 131—the mobile device 20 communicates with the server system using the pre-authorization granted by the identifier token. In exchange, the server system provides data to the mobile device 20 that cannot lead to an identification of the user A, no bank account numbers, no card numbers, no user name, i.e., identity-less data. On the other hand, as the configuration mode (i.e., creating or modifying the user configuration) allows access to identity data for the user A, additional safety steps are performed, as set forth above, to obtain a session token.

It is also considered to have numerous identifier tokens per mobile device 20, with each identifier token being associated with one user configuration. For example, the user A may create user configurations for different projects, with each project being associated with a given source account and a given savings account. Upon reaching 151, the user A may navigate between user configurations (e.g., using a side swap) to select a given project. Hence the server system would recognize the user configuration using the identifier token related to the user configuration.

It is hence observed that the method 100 describes steps executed by the mobile device 20 in collaboration with the server system, to allow the user A to save funds to a savings account by turning on the non web-based application on his/her mobile device 20, and by effecting a single action (i.e., one-click savings action), provided the user configuration has been completed already (and that the identifier token is present in the mobile device 20). In accordance with the method 100, the mobile device 20 may execute additional steps if the user A wants to modify the specifics of the fund transfer.

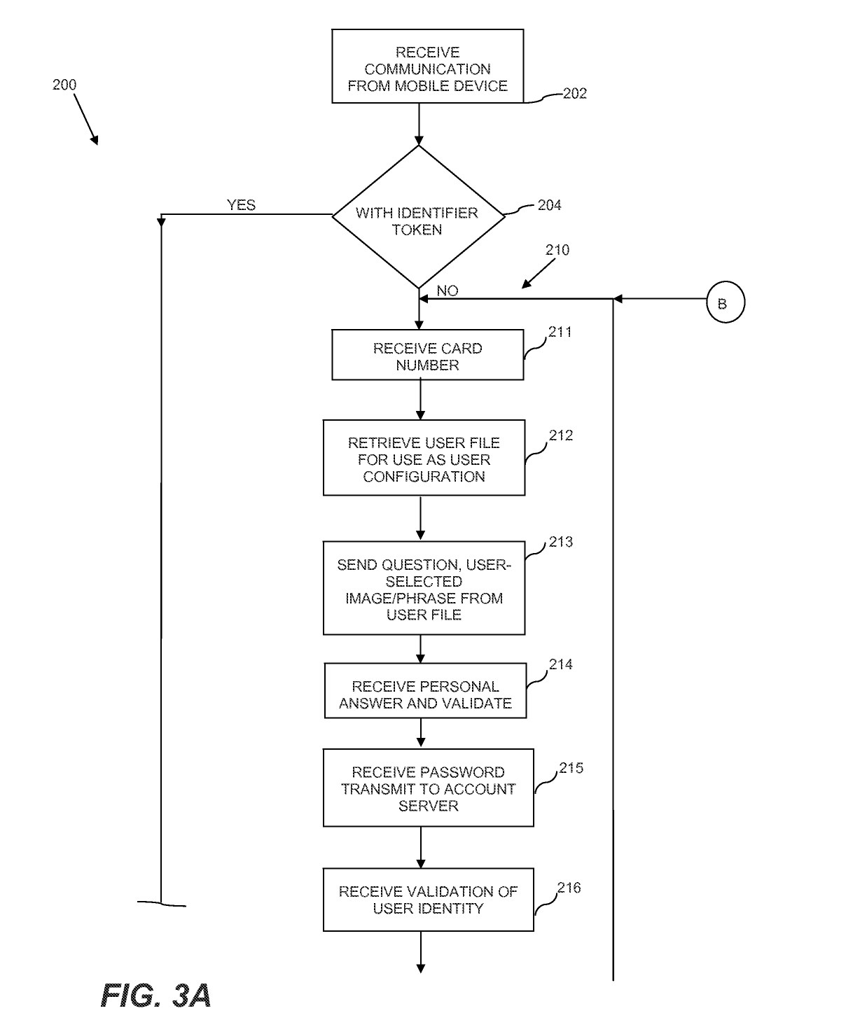

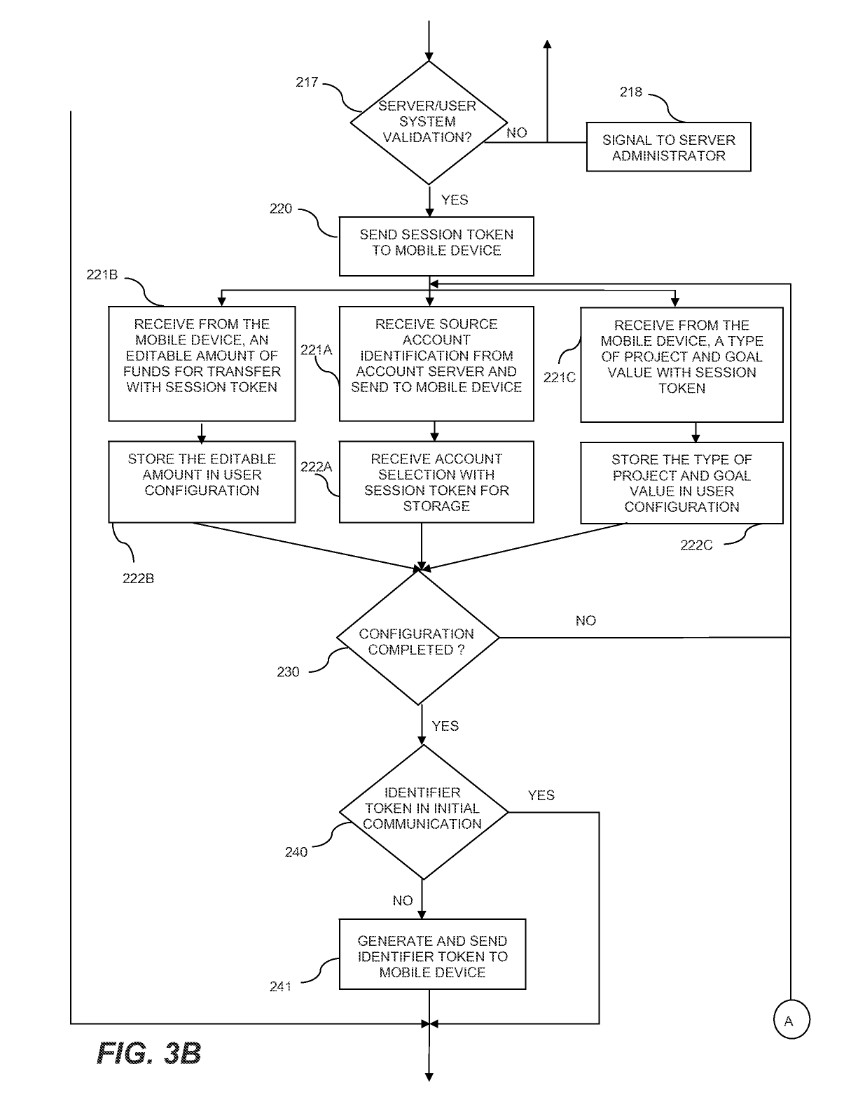

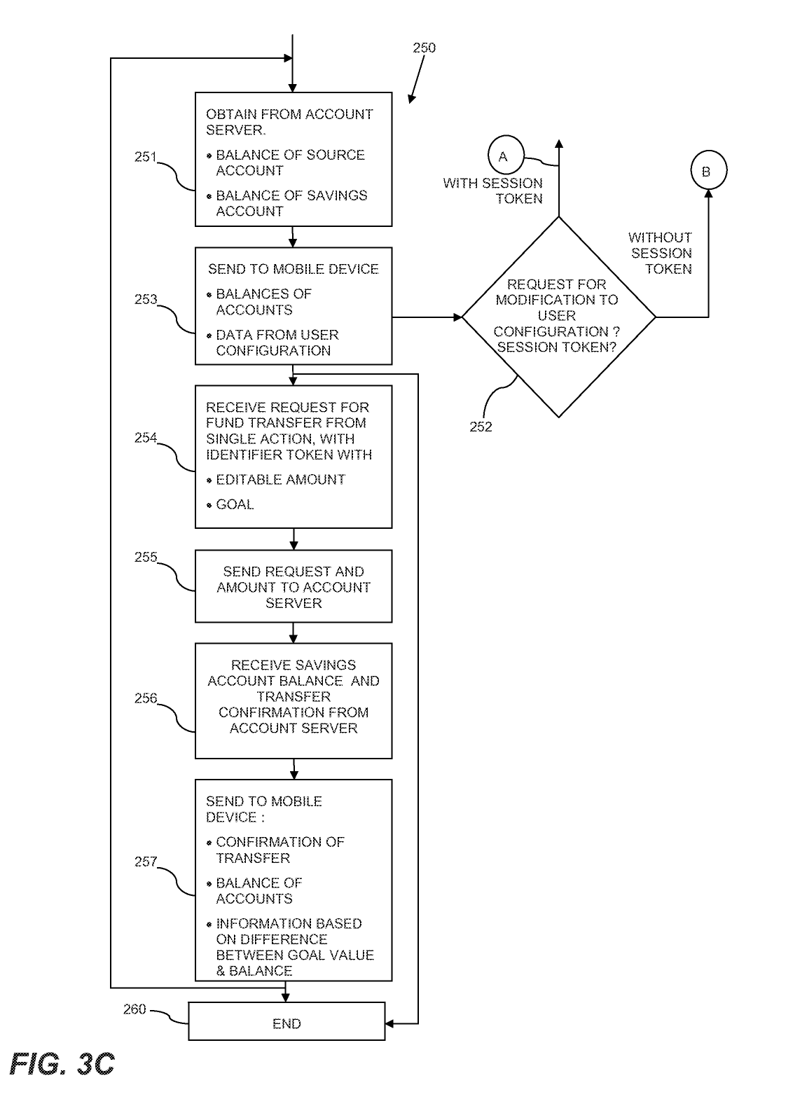

Referring concurrently to FIGS. 1 and 3A-3C, there is illustrated a method for transferring funds to a savings account based on a request from a non-web-based application of a mobile device at 200. The steps of the method 200 are performed by the application server 40, interfacing the mobile device 20 with the account server 30, for fund transfers to be executed in the account server 30.

Prior to performing the method 200, the application server 40 receives a user file from the web login server 50, which user file has information as described hereinafter for the method 200. Data from user file is saved in the databases of the application server 40, as part of the user configuration.

According to 202, the application server 40 receives a communication from the mobile device 20. The communication from the mobile device 202 results from the opening of the non-web-based application in the mobile device 20.

According to 204, the application server 40 will receive this communication with or without the identifier token unique to the mobile device 20, and specifically related to the user A. If the communication is with the identifier token, the mobile device 20 has been previously initiated and configured for using the non-web-based application.

If the communication from the mobile device in 202 is without the identifier token, the application server 40 performs a sequence of steps 210 to validate the identity of the user, the order of which may vary. In 211, the application server 40 receives a card number from the mobile device 20 and associates the card number to the user file.

The card number received at 211 is used to receive or retrieve a user file specific to the user at 212, which user file is stored in the database of the application server 40 as user configuration. The information stored in 212 is described above for FIG. 1.

As part of the user configuration, the application server 40 may retrieve a question and user-selected image/phrase from the user file/configuration, and send same to the mobile device 20, as in 213, for validation. 213 may be done after receiving a password associated with the card number.

In 214, the personal answer produced by the user on the mobile device 20 will be received and the personal answer may be validated with the personal answer in the user file/user configuration. On the other hand, the application server 40 will not receive an indication from the mobile device 20 that the user-selected image/phrase is correct or incorrect, as the user-selected image/phrase in an anti-phishing feature performed by the system.

In 215, the password associated with the card number is received, and the card number and password are transmitted to the account server 30 for validation. Indeed, as described above for FIG. 1, the account server 30 stores the card numbers and passwords, and associates same to the accounts.

As per 216, as a result from the validation by the account server 30, the account server 30 authorizes access to data related to the source accounts and savings accounts. Hence, the application server 40 receives a validation of the user identity, from the account server 30.

Accordingly, two levels of validation are performed, as the validation is accomplished by the account server 30 which seeks another level of validation from the application server 40. The application server 40 will validate the personal answer to the question in steps 213 and 214, while the account server 30 will validate the user identity via the card number and password at 211 to 215.

At 217, if the two levels of validation are not completed, one or more steps 210 are repeated, for instance to ensure that a user identity is validated with the correct password or that the correct personal answer to the question is received. A problem may be signalled at 218 to bank authorities if necessary, if the given number of attempts to login have failed.

If the two-level validation has been done at 217, a session token is sent by the application server 40 to the mobile device 20, at 220. As mentioned previously, the session token is generated by the application server 40, and serves for the opened session on the non-web-based application. The session token of step 220 is required to allow modifications to the user configuration to be made.

User configuration entries and/or modifications are made based on some or all of the steps 221 and 222.

According to 221A, as typically done when the mobile device 20 is initiated, source account identification is received from account servers and sent to the mobile device 20. If there are multiple source accounts, in 222A, an account selection is received from the mobile device 20 along with the session token for storage by the application server 40 in the user configuration. 222A may alternatively be the confirmation from the mobile device 20 that the source account is correct, and may also include a request to create a savings account.

According to 221B, the application server 40 will receive, from the mobile device 20, an editable amount of funds for transfer, along with the session token. At 222B, the editable amount is stored in the user configuration to be submitted to the mobile device 20 when funds are to be transferred.

According to 221C, the application server 40 receives from the mobile device 20 a type(s) of project and a goal value(s) for the project(s), along with the session token, and additional information related to the project(s). For instance, the goal value may be a dollar amount related to the budget required for the project. In 222C, the type of project and the goal value are stored by the application server 40 in the user configuration.

According to 230, if the configuration changes are not completed, any of the various steps 221 and 222 may be performed once more in accordance with the user's preference. Once the configuration is completed, the application server 40 may generate an identifier token for the mobile device 20 at 241, if there is no identifier token present already, as per 240. As mentioned above, the mobile device 20 will have an identifier token if the mobile device 20 has already been initiated and the user configuration is sufficiently complete for single-action transfers to be performed. On the other hand, if the steps of modification to the user configuration have been done to initiate the mobile device 20, an identifier token will be generated and sent to the mobile device according to 241, by the application server 40.

Referring to FIG. 3C, there follows a sequence of steps 250 to transfer the funds.

At 251, the application server 40 receives, from the account server 30, information regarding the accounts, such as the balance of the source account and the balance of the savings account. According to 253, the balances of the various accounts are sent to the mobile device 20. Moreover, data from the user configuration may also be sent to the mobile device 20. The data from the user configuration may include the editable amount of funds for transfer, as well as the type of projects, etc. It is possible to modify the user configuration according to 252, whether it be with the session token or without the session token (when creating the user configuration for first-time login in). If it is without the session token, a session token is required to modify the user configuration. The user configuration may need modification at this point if, for instance, the user wants to add a source account to the ones displayed at 251, or select another default source account in the user configuration. Moreover, after sending the data to the device 20 as in 253, the user A may decide to end the session, as shown in FIG. 3C.

In 254, the application server 40 receives a request for fund transfer from the single action performed on the mobile device 20 (i.e., one-click savings action), along with the identifier token, necessary to perform the transaction. The request may include the editable amount, namely the value of funds for transfer, as well as the goal value, for instance in the case of a project.

In 255, the application server 40 sends the relevant part of the request (i.e., identification of the accounts involved) along with the amount to the account server 30, provided the identifier token has been received and validated by the application server 40. The account server 30 will therefore perform the transfer.

In 256, the account server 30 will send the savings account balance and a transfer confirmation to the application server 40. The balance may then be used in 257 to provide information, for instance calculated by the application server 40, based on the difference between the goal value and the balance. For instance, this information may be the number of transactions required to reach the goal, at the configured editable amount.

Further transfers may be performed, to projects different than the ones involved in the previous transfers, as shown by a return arrow. Otherwise, the transaction ends at 260. It is observed that the steps 251, 253 to 257—those outside user configuration creation/changes—involve identity-less data exchanged between the mobile device 20 and the application server 30, which identity-less data does not provide confidential information enabling an identification of the user A. This is allowed by pre-authorization of identity-less data exchange based on the presence of the identifier token. Therefore, in an embodiment, once the user configuration creation/changes has(have) been made, the mobile device 20 may be used for savings transactions without carrying full bank account numbers.

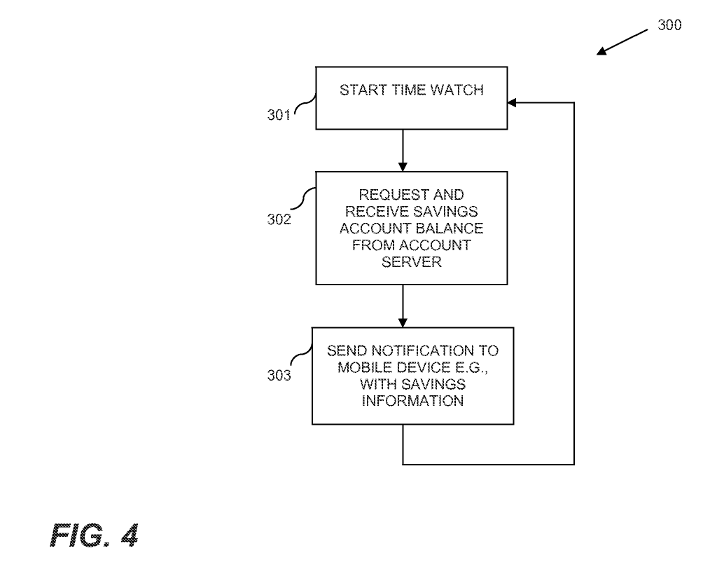

Referring to FIG. 4, there is illustrated a method for notifying the user A of inactivity in fund transfers according to the methods 100 and 200. The method 300 is performed to stimulate or promote savings activity by the user A. The method 300 occurs upon completion of a transfer according to methods 100 and 200, or may occur in response to the initial configuration of the mobile device 20. For instance, the method 300 may be triggered after steps 254, 255 or 260 of FIG. 3C.

According to 301, a time watch is started by the application server 40. The time watch may simply be a timer that determines the amount of time elapsed since the last savings transfer or like triggering action. When a time threshold has been reached, the application server 40 may request and receive savings account balance from the account server 302. This step may occur automatically without interaction from the mobile device 20.

According to 303, a notification is sent to the mobile device 20, for instance with the savings information obtained in 302. It is pointed out that the time watch of 301 may be followed up by the notification of 303 upon the time threshold being reached, i.e., without going through 302. Hence, in such a case, the notification to the mobile device would not comprise the savings information.

It is contemplated to provide the savings information with the notification in any suitable format. For instance, it is considered to have the savings information in terms of the number of transfers required to reach a goal value, with encouraging words, and with a note regarding the period of inactivity. Alternatively, the savings information may be based on the difference between the goal value and the balance. These calculations may be performed by the application server 40. Alternatively, raw data may be sent to the mobile device 20, which may comprise the appropriate algorithms to calculate the balance, required transferred, etc. Upon sending notification according to 303, the method 300 may be repeated to send a further notification until a transfer is made.

While the method 300 is described as being triggered and controlled by the application server 40, it is considered to have the mobile device 20 drive the method 300, by performing the time watch 301 and performing subsequent steps. In the case of 303, the mobile device 20 would generate and display the notification instead of sending it.

In the disclosure provided above, the expression “savings” is used repeatedly, for instance to identify a destination banking account. It is contemplated to have other accounts used as savings account, such as a chequing account, a line of credit account, a credit card account, a loan account, etc, of a same user. For simplicity, the expression savings has been used throughout.

1. A method in a non web-based application of a mobile device for transferring funds to a banking account, the method comprising:
receiving from a server system an identifier token of the mobile device;
persistently storing the identifier token at the mobile device;
when funds are to be transferred:
sending the identifier token stored at the mobile device to the server system when the non web-based application is opened in the mobile device to transfer funds to the banking account,
receiving, from the server system, and displaying information identifying a balance of at least one source account, and an editable amount of funds to be transferred to the banking account, along with an indication of a single action to be performed to transfer the funds to the banking account, and
sending to the server system a request for fund transfer of the editable amount along with the identifier token in response to the single action being performed.

2. The method according to claim 1, further comprising performing a login for creating a user configuration for the mobile device or for modifying the user configuration for the mobile device.

3. The method according to claim 2, wherein performing the login comprises:
requesting a card number associated with the at least one source account to transmit the card number to the server system; and
requesting a password associated with the card number for validation with the server system.

4. The method according to claim 2, wherein performing the login comprises requesting a personal answer to a question for validation with the server system.

5. The method according to claim 3, further comprising:
receiving a session token of the mobile device from the server system after validation, and
creating or modifying the user configuration for the mobile device using the session token therefor.

6. The method according to claim 5, wherein creating or modifying the user configuration comprises:
receiving, from the server system, an identification of at least two of the source account and displaying the identification of the source accounts;
requesting a selection of one of the source accounts for the single action transfer; and
sending to the server system the selection with the session token;
wherein the selected source account is displayed when funds are to be transferred.

7. The method according to claim 5, wherein performing or modifying the user configuration comprises:
requesting a value for the editable amount of funds for the single action transfer; and
sending to the server system the value with the session token;
wherein the value is displayed as the editable amount when funds are to be transferred.

8. The method according to claim 5, wherein performing or modifying the user configuration comprises:
requesting a selection of a type of project for the single action transfer; and
sending to the server system the selection with the session token;
and wherein, when funds are to be transferred:
receiving, from the server system, and displaying information comprises receiving and displaying information identifying the type of project.

9. The method according to claim 8, wherein requesting the selection of the type of project for the single action transfer comprises:
requesting a goal value for the type of project; and
sending to the server system the goal value with the session token;
and wherein, when funds are to be transferred:
receiving, from the server system, and displaying information comprises receiving and displaying information identifying the goal value and a saved value.

10. The method according to claim 9, further comprising, after sending to the server system the request for fund transfer:
receiving, from the server system, and displaying information based on a difference between the goal value and the saved value.

11. The method according to claim 10, further comprising calculating, from the difference between the goal value and the saved value, the number of the single action transfer required, at the configured value of the editable amount, to reach the goal value, and wherein displaying information based on the difference comprises displaying the number of the single action transfer required.

12. The method according to claim 2, wherein performing the login comprises receiving, from the server system, and displaying a user-selected image or phrase for user validation.

13. The method according to claim 2, wherein receiving the identifier token is subsequent to performing the login for creating the user configuration for the mobile device.

14. The method according to claim 1, wherein receiving, from the server system, and displaying information identifying a balance of at least one source account comprises requesting an editable goal value of savings;
and wherein, when funds are to be transferred:
sending to the server system the request for fund transfer of the editable amount along with the identifier token in response to the single action being performed comprises sending the editable goal value of savings.

15. The method according to claim 14, further comprising, after sending to the server system the request for fund transfer with the editable goal value of savings:
receiving, from the server system, and displaying information based on a difference between the editable goal value and a balance of the banking account.

16. The method according to claim 1, wherein receiving the identifier token comprises receiving a unique identifier.

17. The method according to claim 1, wherein, when funds are to be transferred, the displaying of information comprises displaying information of user identity-less nature.

18. A computer program product comprising a computer readable memory storing computer executable instruction thereon that when executed by a mobile device with processor perform the method steps of claim 1.

19. A method for transferring funds to a banking account by a transaction server based on a request from a non web-based application of a mobile device, the method comprising:
upon validation of a user identity via a mobile device, sending an identifier token uniquely identified to mobile device for persistent storage at the mobile device;
when funds are to be transferred by communication from the mobile device with the identifier token:
obtaining, from at least one account server, a balance of at least one source account,
sending to the mobile device the balance of the at least one source account and an editable amount of funds to be transferred to a banking account, for display,
receiving a request for fund transfer of the editable amount along with the identifier token in response to a single action transfer being performed at the mobile device,
recognizing the identifier token, and
sending to the account server the request for fund transfer of the editable amount to the banking account.

20. The method according to claim 19, further comprising validating a user identity for creating a user configuration for the mobile device or for modifying the user configuration for the mobile device.
